(19) United States
(12) Patent Application Publication
(10) Pub. No.: US 2007/0065003 A1
(43) Pub. Date: Mar. 22, 2007

(54) Real-time recognition of mixed source text

(75) Inventors: Eduardo Kellerman, Endicott, NY (US); Rosemary D. Paradis, Vestal, NY (US); Alfred Rundle, Endwell, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Lockheed Martin Corporation

(21) Appl. No.: 11/232,260

(22) Filed: Sep. 21, 2005

(51) Int. Cl. G06K 9/62; G06K 9/00

(52) U.S. Cl. 382/159; 382/181

(57) ABSTRACT

Methods and computer program products are disclosed for the real-time classification of text from a region of interest within an image sample. A feature extractor extracts feature data associated with a plurality of region features from the region of interest. The plurality of region features are selected as to minimize the time necessary for feature extraction. A neural network preclassifier selects one of a plurality of associated source classes for the region of interest according to the extracted feature data. A plurality of classification systems are each associated with one of the plurality of source classes. Each of the plurality of classification systems are operative to classify individual characters within the region of interest when the associated source class of the classification system is selected.

### BACKGROUND OF THE INVENTION

Optical character recognition (OCR) is the process of transforming written or printed text into digital information. Pattern recognition classifiers are used in sorting scanned characters into a number of output classes. A typical prior art classifier is trained over a plurality of output classes using a set of training samples. The training samples are processed, data relating to features of interest are extracted, and training parameters are derived from this feature data. During operation, the system receives an input image associated with one of a plurality of classes. The relationship of the image to each class is analyzed via a classification technique based upon the training parameters. From this analysis, the system produces an output class and an associated confidence value.

One source of error in character recognition is the variance between machine generated text and handwritten or hand printed text. While machine printed characters generally have uniform characteristics even across a variety of fonts, handwritten characters can vary widely. These variations across each character can lower the overall classification accuracy of the system if the same classifier is used. At best, it is difficult and time consuming to segment and identify mixed source text with a reasonable level of accuracy.

Past solutions to this problem have utilized a preclassification stage to identify the source of the text prior to the actual identification of the text characters. By preclassifying the text, hand printed or handwritten text can be diverted from a main classifier, optimized for machine printed text, to a human operator or a specialized classifier. Unfortunately, this extra classification stage can require considerable additional processing time. In addition, the preclassification stage must be retrained each time the sample population changes or a new feature is added. In past systems, retraining has generally involved manually tuning a decision tree for the preprocessor, a process that can weeks to complete.

In some applications, a limited amount of time is available to make a decision about a text sample. For example, in a mail sorting application, a zip code on an envelope or package must be scanned, located, and recognized in a period of less than one hundred milliseconds to maintain the flow of mail through the system. These time constraints limit the available solutions for mitigating the negative effects of mixed source text on classification accuracy.

### SUMMARY OF THE INVENTION

In accordance with one aspect of the present invention, an optical character recognition system is provided for the real-time classification of text from a region of interest within an image sample. A feature extractor extracts feature data associated with a plurality of region features from the region of interest. The plurality of region features is selected as to minimize the time necessary for feature extraction. A neural network preclassifier selects one of a plurality of associated source classes, such as handwriting, machine print or machine script, for the region of interest according to the extracted feature data. A plurality of classification systems is each associated with one of the plurality of source classes. Each of the plurality of classification systems is operative to classify individual characters within the region of interest when the associated source class of the classification system is selected.

In accordance with another aspect of the present invention, a computer program product, operative in a data processing system, is disclosed for classifying text within a region of interest. A feature extraction component extracts feature values associated with a plurality of features relating to the region of interest from an image sample. A preclassifier selects one of a plurality of associated source classes for the region of interest according to the extracted feature values. A plurality of classifiers is each associated with one of the plurality of source classes. Each of the plurality of classifiers is operative to classify individual characters within the region of interest when the associated source class of the classifier is selected. The plurality of features are selected such that the feature extractor and the preclassifier can operate to select one of the plurality of associated source classes within a predetermined period of time.

In accordance with yet another aspect of the present invention, a method is provided for classifying text from a region of interest in real time. A region of interest is identified within a scanned image. A plurality of feature values, associated with a plurality of region features, is extracted from the region of interest. The region of interest is classified into one of a plurality of source classes by a neural network preclassifier according to the extracted feature values. One of a plurality of classification systems are selected according to the source class associated with the region of interest. Individual characters are classified within the region of interest at the selected classification system.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates an optical character recognition (OCR) system that provides real-time recognition of mixed source text in accordance with an aspect of the present invention;

FIG. 2 illustrates an exemplary neural network classifier;

FIG. 3 illustrates an exemplary optical character recognition (OCR) system in accordance with an aspect of the present invention;

FIG. 4 illustrates a methodology for classifying text from mixed text sources in accordance with an aspect of the present invention;

FIG. 5 illustrates a computer system that can be employed to implement systems and methods described herein.

### DETAILED DESCRIPTION OF THE INVENTION

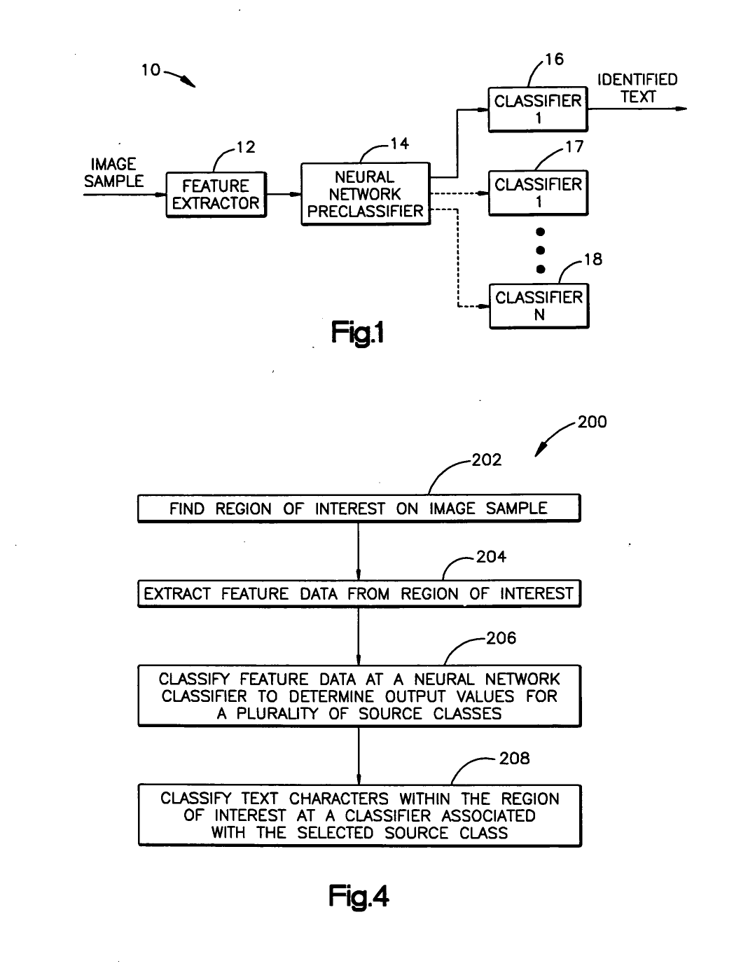

The present invention relates to systems and methods for the real-time recognition of mixed source text. FIG. 1 illustrates an optical character recognition (OCR) system 10 that provides real-time recognition of mixed source text in accordance with an aspect of the present invention. An image sample is provided to a feature extractor 12 that extracts features related to an identified region of interest, in this case, a character, from the image sample. The feature extractor 12 derives a vector of numerical measurements, referred to as feature variables, from the image sample. Thus, the feature vector represents the character image sample in a modified format that attempts to represent all aspects of the original image.

The features used to form the feature vector are selected both for their effectiveness in distinguishing among a plurality of possible text sources and for their ability to be quickly extracted from the image sample. In an exemplary implementation, features such as the size of the region of interest, the shape of the region of interest, and the position of the region of interest within the image sample, have been selected as providing useful information about the text source and can be quickly extracted.

The extracted feature vector is then provided to a preclassifier 14. The preclassifier 14 classifies the text block to determine a property associated with the source of the text. For example, the preclassifier 14 can be an artificial neural network trained to distinguish between text from different sources. Each output class of the preclassifier represents a particular type of text having characteristics related to an associated source. For example, the source classes can include a class for handwritten text, a class for hand printed text, a class for machine printed text, and a class for machine script, a class for italics, etc. Alternatively, the classes can represent different machine script fonts.

A neural network is composed of a large number of highly interconnected processing elements that have weighted connections. It will be appreciated that these processing elements can be implemented in hardware or simulated in software. The organization and weights of the connections determine the output of the network, and are optimized via a training process to reduce error and generate the best output classification. The feature vector is provided to the input of the neural network, and a set of output values corresponding to the plurality of source classes is produced at the neural network output. The source class having the optimal output value is selected. What constitutes an optimal value will depend on the design of the neural network. In one example, the source class having the largest output value is selected.

Once a source class has been selected, the image sample is provided to one of a plurality of classifiers 16-18. It will be appreciated that while the classifiers 16-18 are illustrated functionally as separate entities in FIG. 1, they can be implemented as computer programs on a common processor. Each classifier 16-18 is associated with one of the plurality of sources classes and is optimized to identify text having the characteristics of its associated source class. Accordingly, the preclassifier 14 effectively selects one of the plurality of classifiers 16-18 based upon its classification of the text within the region of interest.

Since the classifiers 16-18 are optimized for text from their respective source classes, the classifiers 16-18 can segment and classify the text within the region of interest with heightened accuracy and efficiency, reducing the overall processing time of the system. Similarly, the features used by the preclassifier 14 are selected both to allow efficient extraction of the features and to allow preclassification of the region of interest text with a neural network of limited complexity. Accordingly, real-time classification of mixed source text can be accomplished with little or no loss of accuracy.

The illustrated system 10 also provides for flexible retraining of the preclassifier to accommodate new features or output classes. For example, the preclassifier 14 can be implemented as a neural network to be trained to accept new data, allowing the system to quickly adapt to changing populations of data. Accordingly, the optical character recognition system 10 of the present invention can be maintained in operation even when the text samples to which it is exposed are subject to frequent change.

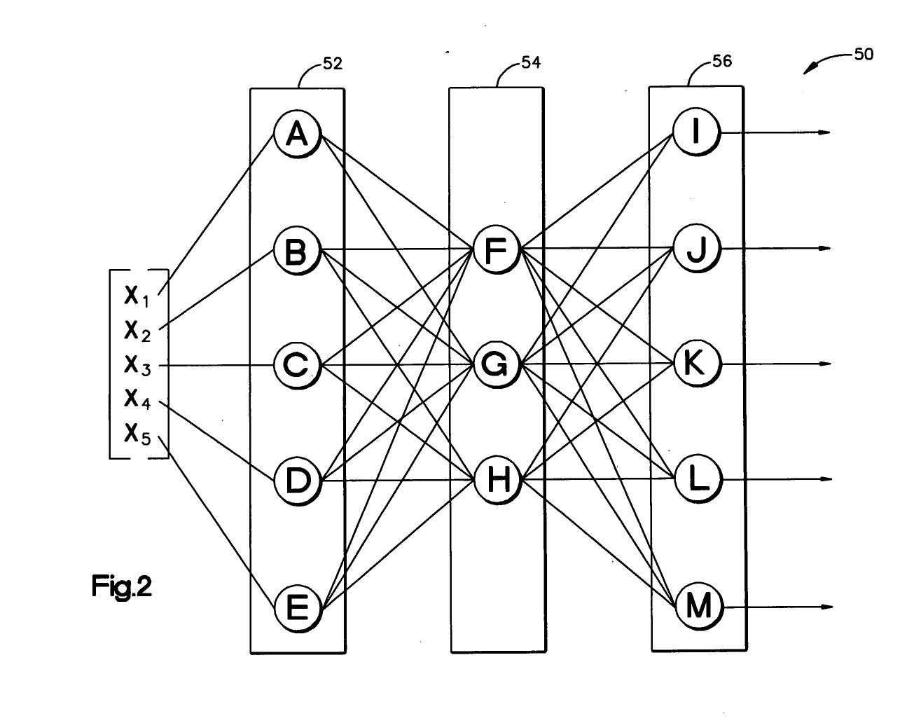

FIG. 2 illustrates an exemplary neural network classifier 50. The illustrated neural network is a three-layer back-propagation neural network suitable for use in an elementary pattern classifier. It should be noted here, that the neural network illustrated in FIG. 2 is a simple example solely for the purposes of illustration. Any non-trivial application involving a neural network, including pattern classification, would require a network with many more nodes in each layer and/or additional hidden layers.

In the illustrated example, an input layer 52 comprises five input nodes, A-E. A node, or neuron, is a processing unit of a neural network. A node may receive multiple inputs from prior layers which it processes according to an internal formula. The output of this processing may be provided to multiple other nodes in subsequent layers. The functioning of nodes within a neural network is designed, in a generalized sense, to mimic the function of neurons within a human brain.

Each of the five input nodes A-E receives input signals with values relating to features of an input pattern. Preferably, a large number of input nodes will be used, receiving signal values derived from a variety of pattern features. Each input node sends a signal to each of three intermediate nodes F-H in a hidden layer 54. The value represented by each signal will be based upon the value of the signal received at the input node. It will be appreciated, of course, that in practice, a classification neural network can have a number of hidden layers, depending on the nature of the classification task.

Each connection between nodes of different layers is characterized by an individual weight. These weights are established during the training of the neural network. The value of the signal provided to the hidden layer 54 by the input nodes A-E is derived by multiplying the value of the original input signal at the input node by the weight of the connection between the input node and the intermediate node (e.g., G). Thus, each intermediate node F-H receives a signal from each of the input nodes A-E, but due to the individualized weight of each connection, each intermediate node receives a signal of different value from each input node. For example, assume that the input signal at node A is of a value of 5 and the weights of the connections between node A and nodes F-H are 0.6, 0.2, and 0.4 respectively. The signals passed from node A to the intermediate nodes F-H will have values of 3, 1, and 2.

Each intermediate node F-H sums the weighted input signals it receives. This input sum may include a constant bias input at each node. The sum of the inputs is provided into a transfer function within the node to compute an output. A number of transfer functions (e.g., Sigmoid, hyperbolic tangent or linear functions) can be used within a neural network of this type. By way of example, a threshold function may be used, where the node outputs a constant value when the summed inputs exceed a predetermined threshold. Alternatively, a linear or sigmoidal function may be used, passing the summed input signals or a sigmoidal transform of the value of the input sum to the nodes of the next layer.

Regardless of the transfer function used, the intermediate nodes F-H pass a signal with the computed output value to each of the nodes I-M of the output layer 56. An individual intermediate node (i.e. G) will send the same output signal to each of the output nodes I-M, but like the input values described above, the output signal value will be weighted differently at each individual connection. The weighted output signals from the intermediate nodes are summed to produce an output signal. Again, this sum may include a constant bias input.

Each output node represents an output class of the classifier. The value of the output signal produced at each output node is intended to represent the probability that a given input sample belongs to the associated class. In the exemplary system, the class with the highest associated probability is selected, so long as the probability exceeds a predetermined threshold value. The value represented by the output signal is retained as a confidence value of the classification.

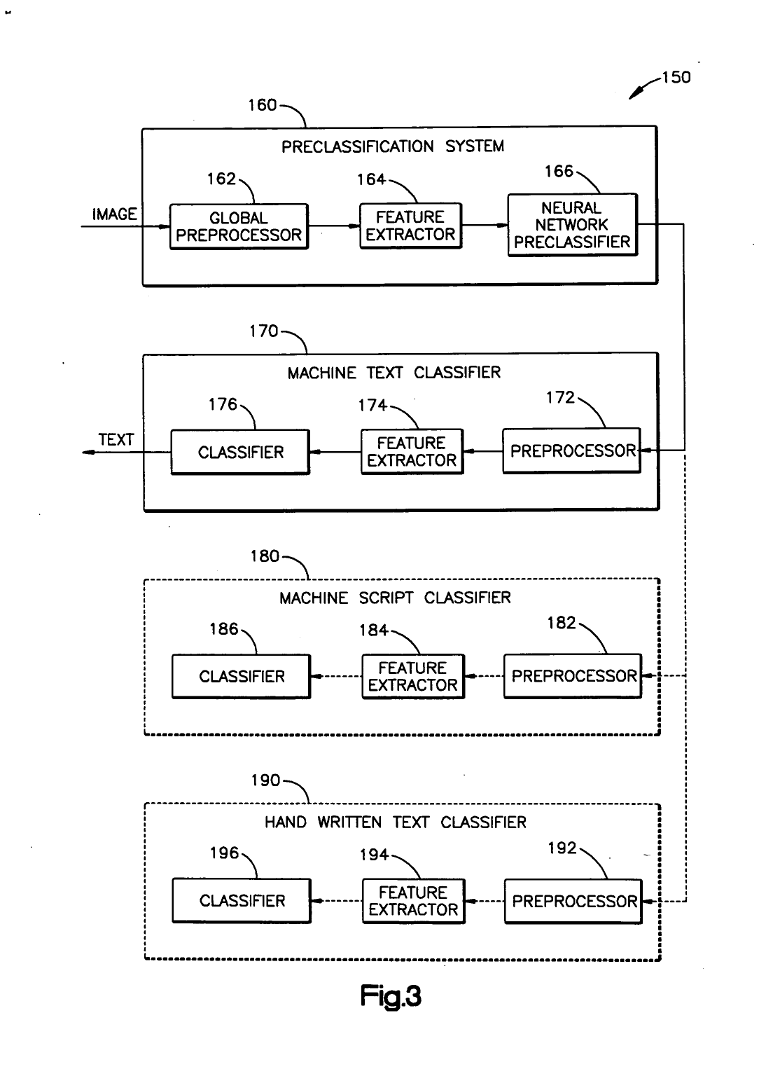

FIG. 3 illustrates an exemplary optical character recognition (OCR) system 150 in accordance with an aspect of the present invention. In the illustrated example, the OCR system 150 is used to identify digitally scanned addresses as part of a mail sorting system. In accordance with an aspect of the present invention, at least a portion the OCR system 150 can be implemented as a hardware implementation of a neural network or as a software program simulating the functioning of a neural network. The structures described herein, may thus be considered to refer to individual modules and tasks within a software program.

The OCR system 150 includes a preclassification system 160 that determines an associated source class of the data. In the illustrated example, the source classes comprise a first source class for machine printed text, a second source class for machine script, and a third source class for handwritten text. The preclassification system 160 includes a global preprocessing component 162 that identifies and segments one or more regions of interest on a digital image. For example, where the digital image represents an envelope, the regions of interest might include an address block on the envelope and the return address block on the envelope. Alternatively, smaller regions of interest, such as individual lines or words of text can be utilized as regions of interest by the preclassification system 160. The global preprocessing component 162 can identify and segment regions of interest within the image and provide them to a feature extractor 164 for analysis.

The feature extractor 164 extracts a plurality of feature values, corresponding to a feature set for the preclassification system 150, from each region of interest in the scanned text. In accordance with an aspect of the present invention, the features used for the preclassifier are selected to ensure that real time processing of the image samples can be maintained. For example, in a mail sorting system, the window of time available to scan an envelope, recognize the text on the envelope, and make a decision on the destination of a given envelope is quite small, for example, less than a tenth of a second. This places significant time restraints on the classification process, particularly in the preclassification portion of the process.

In an exemplary embodiment, a number of the features associated with the feature extractor 164 are associated with the shape of the region of interest and various subregions comprising the region of interest, as one of the distinguishing characteristics of machine-printed text is the uniformity of the text. The subregions can comprise uncombined regions, which are regions of contiguous pixels after a scan, and combined blobs, in which spatially proximate regions of contiguous pixels are combined. Each uncombined regions is intended to correspond roughly with an individual letter, with the combined blobs intended to correct for gaps in letters due to scanning areas. It will be appreciated, however, that in the interest of rapidly acquiring features, the identification of the regions does not amount to a complete segmentation of the characters, but rather a rapid grouping of contiguous and nearly contiguous that, in accordance with an aspect of the present invention, these regions can be quickly identified and combined within a scanned image.

A number of features that are useful for can be determined from the identified regions. For example, the height of each uncombined region can be determined, and the height having the most associated regions can be determined. This height, and an associated number of regions having a height within a narrow range associated with this height, can be utilized as features. Similarly, the second most common height can be used, along with its associated count, and a combined count for the two heights. The difference between the two most common heights can provide another feature. All of these features can also be calculated for the combined blobs.

Similar features sets can be produced with respect to the baseline width and overall width of the combined and uncombined regions. In addition, a slope of the baseline of each combined blob can be determined, and the most common slope can be determined, as well as the number blobs having a slope equal to the most common slope (or within a narrowly defined range around the most common slope). Other features can focus on a comparison (e.g., a ratio or difference) between a first feature (e.g., the baseline or width) and a second feature (e.g., the height) for each region. For example, the one or more most common ratios of baseline width to height among the combined or uncombined regions can be determined along with the number of regions associated with each of the one or more most common ratios. Other useful features will be apparent to one skilled in the art in light of the preceding discussion.

The feature values extracted at the feature selector 164 can be provided, in the form of a feature vector, to a neural network preclassifier 166. The preclassifier 166 selects a source class for the scanned image based upon the provided feature vector. The values comprising the feature vector are provided as input values to the neural network preclassifier 166. The preclassifier 166 processes the input values according to its associated weights and transfer functions to produce an output value for each source class. The source class having the best output value (e.g., largest) from a set of validation data can be selected to provide an output class for the system. The validation data is a separate set of the images that have been selected as a representative example of the entire image collection, and has not been used in the neural network training process.

In accordance with an exemplary implementation, the neural network preclassifier 166 can be designed within certain parameters to ensure that the processing at the preclassifier can be accomplished within the narrow window of time available for preclassification. For example, the number of hidden nodes and hidden layers within the network can be restricted to maintain a desired processing time at the preclassifier 166. In an exemplary embodiment, the neural network 166 can be limited to only one hidden layer and a minimal number of nodes within the hidden layer. One skilled in the art will appreciated that other adjustments to the neural network preclassifier 166 design can be made to provide a desired processing time at the preclassifier.

In accordance with an embodiment of the present invention, one of a plurality of classification systems 170, 180, and 190 can be selected according to the determined source class of the image. In the exemplary embodiment, images containing machine printed text are provided to a first classification system 170, images containing machine script text are provided to a second classification system 180, and images containing hand written text can be provided to a third classification system 190. Generally, only one of the classification systems will be active at a given time, as indicated by the dotted lines and boxes in FIG. 3. In an alterative embodiment, all of the classification systems are operated and the highest classification from each net is selected. In such a case, the features utilized in the classification can be changed at each classifier according to the selected source class.

The classification systems include respective regional preprocessing components 172, 182, and 192. The regional preprocessing components (e.g., 172) segment the incoming images into individual text characters. It will be appreciated that the segmentation of the characters can vary according to the source of the characters. For example, a segmentation algorithm used to segment machine printed characters in an equal spacing font can operate very differently from an algorithm used to separate hand written characters. The regional preprocessing components 172, 182, and 192 can also filter any remaining noise from the segmented images and normalize the segmented characters, if necessary for their respective classification systems 170, 180, and 190.

The preprocessed images can be provided to respective feature extraction components 174, 184, and 194 at each classification system 170, 180, and 190 that analyze preselected features of the pattern. The selected features can be any values derived from the pattern that vary sufficiently among the various output classes to serve as a basis for discriminating between them. It will be appreciated that the features used at each feature extraction stage will depend on its associated source class. Numerical data extracted from the features can be conceived for computational purposes as a feature vector, with each element of the vector representing a value derived from one feature within the pattern. Possible features analysis in an OCR application might include dividing the image into a number of regions and recording the proportion of each region occupied by the character. Alternatively, the ratio of the base of the character to its height might be recorded as a feature. One skilled in the art will appreciate other possible features for the feature extraction systems.

The extracted feature vector can then be provided to respective classification components 176, 186, and 196. The classification components 176, 186, 196 analyze the feature vector to generate a classification result and an associated confidence value. The classification result identifies the character associated with the feature vector, while the confidence value indicates likelihood that the classification is correct. The classifiers 176, 186, and 196 can include any of a number of classification algorithms or structures. For example, each classifier 176, 186, and 196 can include one or more neural network classifiers, statistical classifiers, self-organizing maps, and contextual classifiers that have been designed or adapted to recognize characters from the source class associated with the classifier. The particular classifier or classifiers utilized in each classification system 170, 180, and 190 can vary such that, for example, a first classification system 170 can use a statistical classifier, a second classification system 180 can utilize a neural network classifier, and a third classifier can utilize multiple classifiers arbitrated by a rule based system.

Typically, each classifier 176, 186, and 196 will have been trained on a series of training samples belonging to the source class prior to operation of the system. In a training mode, internal parameters (e.g., weights, statistical parameters, etc.) are computed from this training set of pattern samples. To compute the training data, numerous representative pattern samples are needed for each output class. The pattern samples are converted to feature vectors via preprocessing and feature extraction stages similar to that described above. The parameters for each classifier 176, 186, and 196 can be determined from these feature vectors according to known training methodologies associated with the classifier.

FIG. 4 illustrates a methodology 200 for classifying text from mixed text sources in accordance with an aspect of the present invention. The methodology begins at step 202, where a region of interest (ROI) is located on the image sample. The region of interest can be located by scanning the image sample for regions having nonuniform levels of brightness that are similar in form to text. It will be appreciated that in most applications, there will be some prior knowledge of the attributes (e.g., approximate size and location) of the region of interest to allow an appropriate region to be selected. In an exemplary implementation of a mail sorting system, the region of interest may include all or a portion of a destination address on the envelope. Accordingly, the region of interest can be identified as a moderately large region of nonuniform brightness near the center of the envelope side bearing the stamp. Other methods for identifying the region of interest will be apparent to one skilled in the art.

Once the region of interest is located on the sample, the methodology advances to step 204, where data associated with image features can be extracted from the region of interest. These image features can include features associated with the size, shape, and pixel density of the region, as well as the size, shape, and pixel density of subregions defined within the region of interest. At step 206, the extracted feature data can be classified into an associated source class at a neural network classifier. For example, the source classes can represent different font types for printed text or different entities that generate the text (e.g., machine generated text versus handwritten text). During the classification, an output value for each source class can be determined from the extracted feature data. The source class having the best output value is selected. At step 208, at least one text character within the region of interest is classified at a classifier designed to efficiently classify text characters belonging to the selected source class.

It will be appreciated that these features can be selected, by an automated optimization process, for example, such that the feature extraction process and the classification of the extracted image features can be accomplished in a very short period of time. In an exemplary mail sorting application, each envelope is only viewed by a scanner for a brief time before it must be identified and directed to its destination. Accordingly, it is necessary to locate and identify the zip code on a given envelope within a very short time period (e.g., less than 100 milliseconds). In this implementation, the design of the neural network classifier and the particular set of features utilized is selected such that the identification of the region of interest (step 202), the extraction of the features (step 204), and the source classification (step 206) can be accomplished in less than fifty milliseconds. By identifying the source of the text quickly, the majority of the time window is made available for identifying the individual characters of the zip code.

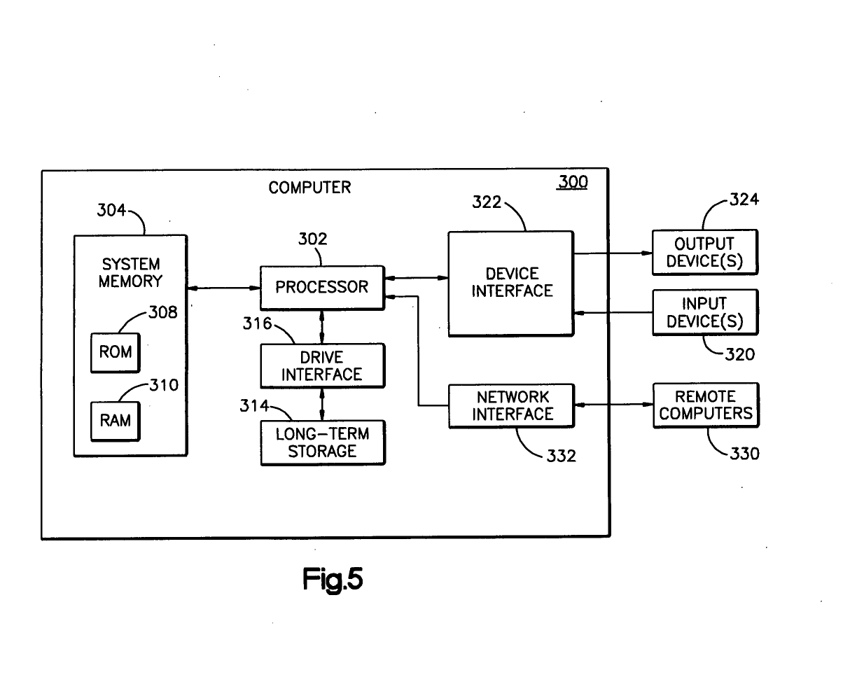

FIG. 5 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. A system bus 306 couples various system components, including a coupling of the system memory 304 to the processor 302. Dual microprocessors and other multi-processor architectures can also be utilized as the processor 302. The system bus 306 can be implemented as any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) 312 can reside in the ROM 308, generally containing the basic routines that help to transfer information between elements within the computer system 300, such as a reset or power-up.

The computer system 300 can include a hard disk drive 314, a magnetic disk drive 316, (e.g., to read from or write to a removable disk 318), and an optical disk drive 320, (e.g., for reading a CD-ROM or DVD disk 322 or to read from or write to other optical media). The hard disk drive 314, magnetic disk drive 316, and optical disk drive 320 are connected to the system bus 306 by a hard disk drive interface 324, a magnetic disk drive interface 326, and an optical drive interface 334, respectively. The drives and their associated computer-readable media provide nonvolatile storage of data, data structures, and computer-executable instructions for the computer system 300. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital versatile disks and the like.

A number of program modules may also be stored in one or more of the drives as well as in the RAM 310, including an operating system 330, one or more application programs 332, other program modules 334, and program data 336.

A user may enter commands and information into the computer system 300 through user input device 340, such as a keyboard or a pointing device (e.g., a mouse). Other input devices may include a microphone, a joystick, a game pad, a scanner, a touch screen, or the like. These and other input devices are often connected to the processor 302 through a corresponding interface or bus 342 that is coupled to the system bus 306. Such input devices can alternatively be connected to the system bus 306 by other interfaces, such as a parallel port, a serial port or a universal serial bus (USB). One or more output device(s) 344, such as a visual display device or printer, can also be connected to the system bus 306 via an interface or adapter 346.

The computer system 300 may operate in a networked environment using logical connections 348 to one or more remote computers 350. The remote computer 348 may be a workstation, a computer system, a router, a peer device or other common network node, and typically includes many or all of the elements described relative to the computer system 300. The logical connections 348 can include a local area network (LAN) and a wide area network (WAN).

When used in a LAN networking environment, the computer system 300 can be connected to a local network through a network interface 352. When used in a WAN networking environment, the computer system 300 can include a modem (not shown), or can be connected to a communications server via a LAN. In a networked environment, application programs 332 and program data 336 depicted relative to the computer system 300, or portions thereof, may be stored in memory 354 of the remote computer 350.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. An optical character recognition (OCR) system for the real-time classification of text from a region of interest within an image sample, comprising:
a feature extractor that extracts feature data associated with a plurality of region features from the region of interest;
a neural network preclassifier that selects one of a plurality of associated source classes for the region of interest according to the extracted feature data; and
a plurality of classification systems, each of the plurality of classification systems being associated with one of the plurality of source classes and being operative to classify individual characters within the region of interest when the associated source class of the classification system is selected.

2. The system of claim 1, further comprising a global preprocessing component that identifies and segments the region of interest from the image sample.

3. The system of claim 2, a given classification system comprising a regional preprocessing component that segments the region of interest into individual characters.

4. The system of claim 1, the plurality of region features being selected as to minimize the time necessary for feature extraction.

5. The system of claim 1, the plurality of classification systems including a first classification system, the first classification system comprising a statistical classifier.

6. The system of claim 5, the plurality of classification systems including a second classification system, the second classification system comprising a plurality of classifiers arbitrated by a rule based system.

7. The system of claim 1, a given classification system comprising a feature extractor that extracts a set of character features from individual characters comprising the region of interest.

8. A mail sorting system incorporating the OCR system of claim 1, the image sample comprising a scanned envelope and the region of interest comprising an address block on the envelope.

9. A computer program product, implemented on a computer readable medium and operative in a data processing system, for the real-time classification of text within a region of interest, comprising:
a feature extraction component that extracts feature values associated with a plurality of features relating to the region of interest from an image sample;
a preclassifier that selects one of a plurality of associated source classes for the region of interest according to the extracted feature values; and
a plurality of classifiers, each of the plurality of classifiers being associated with one of the plurality of source classes and being operative to classify individual characters within the region of interest when the associated source class of the classifier is selected;
wherein the feature extractor and preclassifier are configured such that the feature extractor and the preclassifier can operate to select one of the plurality of associated source classes within a predetermined period of time.

10. The computer program product of claim 9, the predetermined period of time having a duration of less than fifty milliseconds.

11. The computer program product of claim 9, the preclassifier comprising a software simulation of an artificial neural network.

12. The computer program product of claim 9, wherein a first classifier from the plurality of classifiers is associated with machine printed text, such that machine printed characters are classified at the first classifier, and a second classifier of the plurality of classifiers is associated with hand written text, such that hand written characters are classified at the second classifier.

13. The computer program product of claim 9, wherein a third classifier of the plurality of classifiers is associated with machine script, such that machine script characters are classified at the third classifier.

14. A method for classifying text from a region of interest in real-time comprising:
identifying a region of interest within a scanned image;
extracting a plurality of feature values, associated with a plurality of region features, from the region of interest;
classifying the region of interest into one of a plurality of source classes at a neural network preclassifier according to the extracted feature values;
selecting one of a plurality of classification systems according to the source class associated with the region of interest; and
classifying individual characters within the region of interest at the selected classification system.

15. The method of claim 14, further comprising extracting feature data corresponding to a plurality of character features from each individual character, the individual characters being classified according to the feature data associated with the character features.

16. The method of claim 14, wherein the step of extracting a plurality of feature values comprises:
identifying regions of connected pixels;
determining at least one characteristic of each identified region;
combining sets of at least one spatially proximate identified region into combined blobs; and
determining at least one characteristic of each combined blob.

17. The method of claim 16, wherein the identified characteristic includes at least one of the width, length, and baseline width of identified regions.

18. The method of claim 16, further comprising the steps of:
calculating at least feature value from the determined at least one characteristic of the identified regions; and
calculating at least one feature value from the determined at least one characteristic of the combined blobs.

19. The method of claim 16, wherein the step of calculating at least feature value from the determined at least one characteristic of the identified regions comprises:
determining a most common height of the identified region; and
determining a number of identified regions having associated heights within a range associated with the most common height.

20. The method of claim 15, wherein the steps of extracting a plurality of feature values and classifying the region of interest into one of a plurality of source classes are performed within a predetermined period of time.
